(19) United States
(12) Patent Application Publication
(10) Pub. No.: US 2025/0350218 A1
(43) Pub. Date: Nov. 13, 2025

(54) ELECTRICAL GENERATION SYSTEM FOR AN AIRCRAFT, AND ASSOCIATED METHOD

(71) Applicant: SAFRAN ELECTRICAL & POWER, BLAGNAC (FR)

(72) Inventors: Quentin MAUVIEL, MOISSY-CRAMAYEL (FR); Mathieu MAZARIN, MOISSY-CRAMAYEL (FR); Geoffrey BEGGIORA, MOISSY-CRAMAYEL (FR)

(21) Appl. No.: 19/196,941

(22) Filed: May 2, 2025

(30) Foreign Application Priority Data
May 11, 2024 (FR) 2404852

(51) Int. Cl. H02P 9/02; B64D 47/00

(52) U.S. Cl. CPC H02P 9/02; B64D 47/00; B64D 2221/00

(57) ABSTRACT

An electrical generation system for supplying at least one electrical network of an aircraft. The electrical generation system includes a control device configured to receive a general operating setpoint and to output a first parameterization setpoint for the first converter and a second parameterization setpoint for the second converter. Each parameterization setpoint being either a voltage regulation setpoint for slaving the converter to a distribution voltage or an auxiliary regulation setpoint for the turbomachine. The control device being configured to output a parameterization setpoint in relation to an auxiliary transition with a stabilization delay relative to a parameterization setpoint in relation to a voltage transition so that the voltage regulation is extended during an auxiliary transition.

### TECHNICAL FIELD

The present invention relates to an electrical generation system for an aircraft and, more generally, to an electrical hybridization system for an aircraft.

The climate change is a major concern for many legislative and regulatory bodies around the world. In fact, various restrictions on carbon emissions have been, are being or will be adopted by various States. In particular, an ambitious standard applies both to new aircraft types and to those already in circulation, requiring the implementation of technological solutions to bring them into line with current legislations. The civil aviation industry has been mobilizing for several years now to make a contribution to the fight against climate change.

The technological research efforts have already allowed for a very significant improvement in the environmental performance of aircraft. The Applicant takes into consideration the impacting factors in all phases of design and development to obtain aeronautical components and products that are more energy efficient, more environmentally friendly and whose integration and use in civil aviation have moderate environmental consequences with the aim of improving the energy efficiency of aircraft.

This ongoing research and development work focuses in particular on new generations of hybrid thermal and electric aircraft engines. The Applicant's objective is to develop aircraft incorporating a high-power electrical generation system. This would allow the amount of electrical equipment on board to be increased in order to reduce fuel consumption.

In practice, in a conventional aircraft turbomachine, it is known to integrate an electric generator that takes mechanical energy from the low pressure shaft of the aircraft turbomachine to produce electrical energy that is distributed to an electrical energy distribution unit.

To increase electrical energy generation, with reference to FIG. 1, an electrical generation system 100 is proposed, configured to draw on the first hand mechanical energy from a low-pressure shaft BP and on the other hand mechanical energy from a high-pressure shaft HP of an aircraft turbomachine T to supply an aircraft electrical network REA with a calibrated distribution voltage. In other words, the electrical generation system 100 comprises at least two supply paths, in this case a path BP and a path HP. The electrical generation system 100 can also be connected to electrical sources BAT or electrical charges LOAD.

In practice, the electrical generation system 100 is configured to receive a operating setpoint P_{ECU} from a computer ECU of the turbomachine T. This operating setpoint P_{ECU} allows determining, for example, the amount of electrical power to be generated, the mechanical extraction on each shaft, etc. In other words, the operating setpoint P_{ECU} allows determining the hybridization strategy selected.

With reference to FIG. 2, the electrical generation system 100 comprises two generators G1, G2 (electrical sources) connected respectively to the low-pressure shaft BP and the high-pressure shaft HP of the turbomachine T. The electrical generation system 100 also includes two converters C1, C2, in particular inverters, which are respectively associated with the two generators G1, G2. Each generator G1, G2 generates an alternating current which is then rectified by its converter C1, C2 to supply a distribution voltage V_{DC} to an electrical distribution unit EDU which is electrically connected to the aircraft electrical network REA, to the electrical sources BAT or to the electrical charges LOAD.

This example illustrates an application related to electrical generation, but the invention applies more generally to the field of hybridization, wherein an electrical machine performs, on the one hand, a generator function to draw mechanical power from the low-pressure BP shaft or the high-pressure shaft HP and, on the other hand, a motor function to inject mechanical power onto the low-pressure shaft HP or the high-pressure shaft HP. For a motor function, each C1, C2 converter can also convert the DC voltage V_{DC} to supply alternating current to the two electrical machines G1, G2 respectively, in order to inject power.

For the sake of clarity and conciseness, only the generating function is presented. For a motor function, the computer ECU provides an operating setpoint P_{ECU} allowing the determination, for example, of the injection of mechanical power on each shaft, etc. The hybridization system is bidirectional to allow the generation of electrical power but also the injection of mechanical power. The computer ECU allows for general supervision by determining an operating setpoint P_{ECU} that depends on the availability and capacity of the electrical sources as well as the needs of the electrical charges.

As is well known, each converter C1, C2 comprises a plurality of switches, in particular power transistors, which allow the modification of the electrical power generated and the electrical power drawn by each generator G1, G2 on each shaft BP, HP. The electrical generation system 100 includes a control device 200 for outputting parameterization setpoints P_{CONS1}, P_{CONS2} to each converter C1, C2 as a function of the operating setpoint P_{ECU} so as to obtain a distribution voltage V_{DC} that is adapted to the electrical distribution unit EDU.

In a known way, each converter C1, C2 is configured to receive parameterization setpoints P_{CONS1}, P_{CONS2} of several types:
A voltage regulation setpoint RegU configured to slave the converter C1, C2 to the distribution voltage V_{DC},
An auxiliary regulation setpoint RegA configured to slave the converter C1, C2 to a requested power or torque of the aircraft turbomachine T.

In particular, the control device 200 can determine the type of regulation of each converter C1, C2 by determining the parameterization setpoint P_{CONS1}, P_{CONS2}.

In practice, the control device 200 is connected to each converter C1, C2 by one or more communication cables (point-to-point or multi-subscriber link) to communicate the parameterization setpoint P_{CONS1}, P_{CONS2}. Such communication cables, particularly of the CAN type, enable parameterization setpoint P_{CONS1}, P_{CONS2} to be communicated approximately every 15 ms, which is slow. It is therefore not possible to implement reactive and dynamic regulation.

In nominal operation, a first converter C1 is generally regulated in voltage RegU in order to optimally control the distribution voltage V_{DC} while the second converter C2 is regulated in an auxiliary manner RegA.

Depending on the circumstances, it may be advisable to reverse the role of the converters C1, C2. To this end, with reference to FIG. 3, the computer ECU determines an operating setpoint P_{ECU} which commands a role reversal. The control device 200 determines parameterization setpoints P_{CONS1}, P_{CONS2} for reversing the roles of the converters C1, C2. So, when the first parameterization setpoint P_{CONS1} is received, the first converter C1 switches from a voltage regulation RegU to an auxiliary regulation RegA. Conversely, on receipt of the second parameterization setpoint P_{CONS2}, the second converter C2 switches from an auxiliary regulation RegA to a voltage regulation RegU.

In practice, such a role reversal is complex, as the distribution voltage V_{DC} must be optimally controlled during a transition between two types of regulation. In addition, the electrical generation system must be robust in the event of the loss of one or more parameterization setpoints P_{CONS1}, P_{CONS2} on the communication cables. Indeed, with reference to FIG. 4, if the second P_{CONS2} setpoint is transmitted with a parasitic delay Tp, the two converters C1, C2 are both regulated in an auxiliary manner RegA, which is a source of instability INST for the distribution voltage V_{DC} as illustrated in FIG. 5.

The invention thus seeks to eliminate these disadvantages by proposing a method of regulating an electrical generation system which eliminates at least some of these drawbacks.

### Presentation of the Invention

The invention relates to an electrical generation system for supplying at least one electrical network of an aircraft, the aircraft comprising at least one aircraft turbomachine comprising a low-pressure shaft and a high-pressure shaft configured to be driven in rotation, the electrical generation system being configured to receive a general operating setpoint defining a hybridization strategy, the electrical generation system comprising:
An electrical distribution unit with a distribution voltage,
A first supply path comprising:
   A first generator configured to generate an alternating current by drawing mechanical energy from one of the low-pressure and high-pressure shafts,
   A first converter, associated with the first generator for supplying the electrical distribution unit, to convert the alternating current generated into a first distribution current as a function of its parameterization,
A second supply path comprising:
   A second generator configured to generate an alternating current by drawing mechanical energy from the other of the low-pressure and high-pressure shafts,
   A second converter, associated with the second generator for supplying the electrical distribution unit, to convert the alternating current generated into a second distribution current as a function of its parameterization,
A control device configured to receive the general operating setpoint and output a first parameterization setpoint for the first converter and a second parameterization setpoint for the second converter,
each parameterization setpoint being either a voltage regulation setpoint for slaving the converter to a distribution voltage, or an auxiliary regulation setpoint for the turbomachine,
the control device being configured to output a parameterization setpoint in relation to an auxiliary transition, defined during a transition from a voltage regulation setpoint to an auxiliary regulation setpoint, with a stabilization delay relative to a parameterization setpoint in relation to a voltage transition, defined during a transition from an auxiliary regulation setpoint to a voltage regulation setpoint, so that the voltage regulation is extended during an auxiliary transition.

The introduction of a stabilization delay during an auxiliary transition advantageously enables the distribution voltage of the electrical distribution unit to be kept stable. This timing allows sufficient time for the voltage transition. In other words, this forces a temporary parallelization of the voltage regulation of the two converters in order to guarantee the quality of the electrical network. This allows for a switchover to voltage regulation before a switchover to auxiliary regulation.

The stabilization delay is at least greater than the maximum latency time for the converters to receive the general operating setpoint.

In one aspect, the stabilization delay is greater than 2 ms. Such a stabilization delay allows a time delay greater than the maximum parasitic delay.

In one aspect, the stabilization delay is less than 45 ms. A stabilization delay of this kind means that we can maintain a high level of reactivity when the regulation system is changed.

According to one aspect, the stabilization delay is greater than a maximum parasitic delay determined between an instant of emission of a parameterization setpoint in relation to a transition and an instant of effective switchover from one regulation to another. This allows for a switchover to voltage regulation before a switchover to auxiliary regulation.

In one aspect, the stabilization delay is less than three times the maximum parasitic delay. A stabilization delay of this kind means that we can maintain a high level of reactivity when the regulation system is changed. In one aspect, the stabilization delay is substantially equal to twice the maximum parasitic delay. This stabilization delay ensures a compromise between stability and responsiveness.

According to one aspect, the control device comprises a regulation block configured to calculate a deviation between a measurement of the distribution voltage and a distribution voltage setpoint, the regulation block comprising a gain parameter which is proportionally dependent on the deviation. This prevents power drift during temporary parallelization.

According to one aspect, the regulation block is of the “proportional integral” type, the gain parameter being an integration gain. The gain parameter is very low when the voltage error is low, and increases with voltage error. This avoids power drift between the two converters during parallelization.

Also presented is an aircraft comprising at least one aircraft turbomachine comprising a low-pressure shaft and a high-pressure shaft configured to be driven in rotation, at least one electrical generation system, as previously presented, supplying at least one electrical network of the aircraft.

Also presented is an electrical generation method for supplying at least one electrical network of an aircraft from an electrical generation system as previously presented, the aircraft comprising at least one aircraft turbomachine comprising a low-pressure shaft and a high-pressure shaft configured to be driven in rotation, the method comprising steps consisting of:
Receiving a general operating setpoint defining a hybridization strategy,
From the general operating setpoint, outputting a first parameterization setpoint for the first converter and a second parameterization setpoint for the second converter,
A parameterization setpoint in relation to an auxiliary transition is output with a stabilization delay relative with a parameterization setpoint relative to a voltage transition, so that the voltage regulation is extended during an auxiliary transition.

A computer program-type product is also presented, comprising at least one sequence of instructions stored and readable by a processor and which, when read by this processor, causes the steps of the previously presented method to be carried out.

### PRESENTATION OF FIGURES

The invention will be better understood on reading the following description, which is given by way of example, with reference to the following figures, given by way of non-limiting examples, in which identical references are given to similar objects.

FIG. 1 is a schematic representation of an electrical generation system drawing mechanical energy from an aircraft turbomachine.

FIG. 2 is a schematic representation of the electrical generation system with its generators, converters, electrical distribution unit and control device.

FIG. 3 is a schematic representation of a theoretical change in the regulation of the converters.

FIG. 4 is a schematic representation of a change in converter regulation following a parasitic delay.

FIG. 5 is a schematic representation of distribution voltage instability due to parasitic delay.

FIG. 6 is a schematic representation of an electrical generation system for extracting mechanical energy from an aircraft turbomachine, according to one embodiment of the invention.

FIG. 7 schematically shows an auxiliary transition with a stabilization delay and a voltage transition.

FIG. 8 is a schematic representation of the transmission of a parameterization setpoint with a stabilization delay.

FIG. 9 is a schematic representation of the switchover delay between the two converters.

FIG. 10 is a schematic representation of the stabilization delay and switchover delay.

FIG. 11 is a schematic representation of the distribution voltage without instability following the introduction of the stabilization delay.

FIG. 12 is a schematic representation of a regulation block for parallel regulation during the switchover delay.

FIG. 13 shows schematically the evolution of distribution voltage and electrical power generated for the prior art and for the present invention.

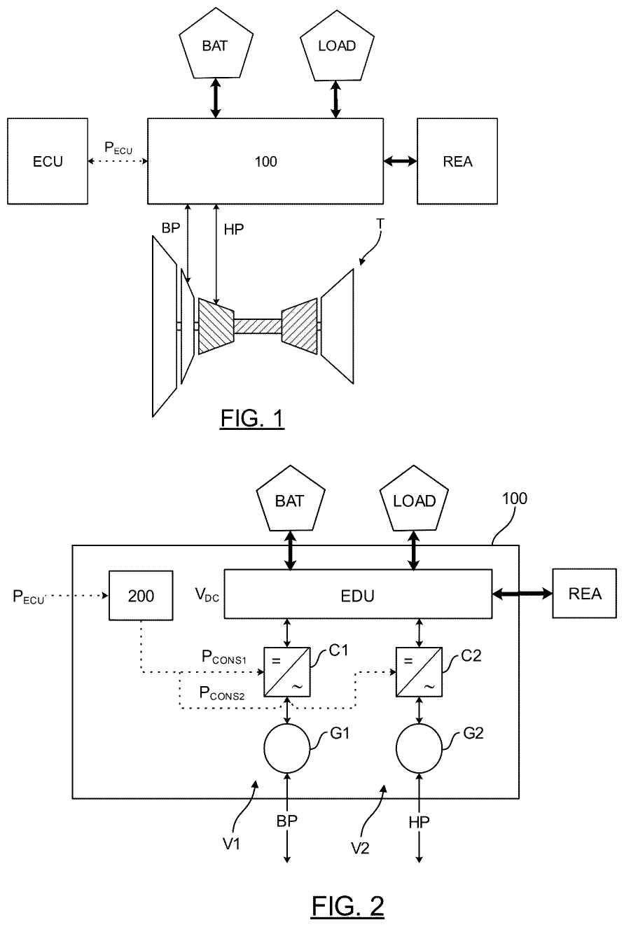

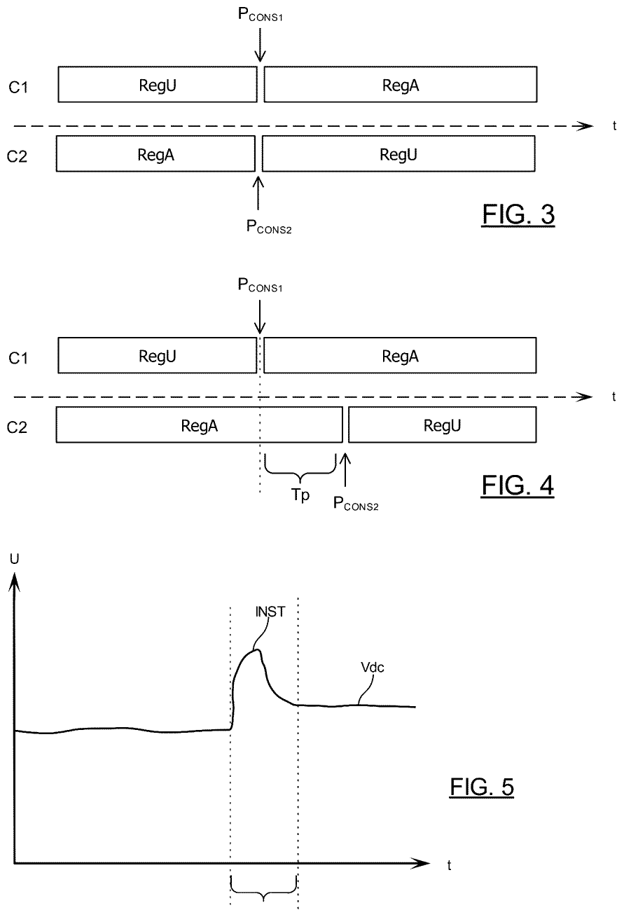

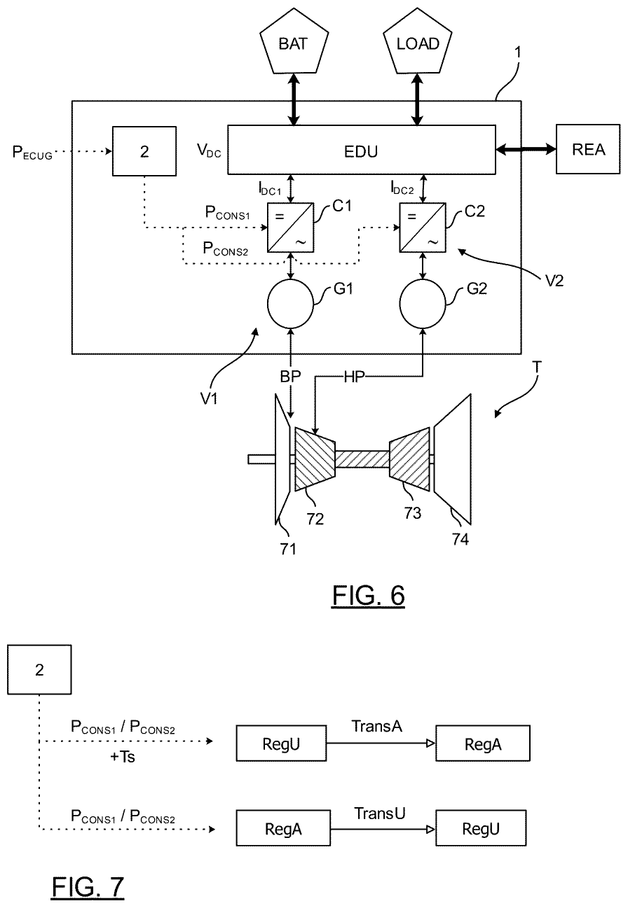

It should be noted that the figures set out the invention in detail for implementing the invention, said figures of course being able to be used to better define the invention where appropriate.

### DETAILED DESCRIPTION OF THE INVENTION

FIG. 6 shows an electrical generation system 1 for an aircraft. The aircraft comprises a turbomachine T with a low-pressure shaft BP and a high-pressure shaft HP. In this example, the turbomachine T comprises a low-pressure compressor 71 and a low-pressure turbine 74, which are connected by the low-pressure shaft BP, and a high-pressure compressor 72 and a high-pressure turbine 73, which are connected by the high-pressure shaft HP.

The electrical generation system 1 is configured to draw mechanical energy from the low-pressure shaft BP, on the one hand, and mechanical energy from the high-pressure shaft HP, on the other, in order to supply an aircraft electrical network REA with a calibrated voltage. The electrical generation system 1 can also be connected to electrical sources BAT or electrical equipment to be supplied LOAD.

In practice, as will be shown later, the electrical generation system 1 more generally allows electrical hybridization to enable power to be drawn from or injected into the turbomachine T.

The electrical generation system 1 is configured to receive a general operating setpoint P_{ECUG} from a computer ECU of the turbomachine T. This general operating setpoint P_{ECUG} is used to determine, for example, the amount of electrical power to be generated, the mechanical load on each shaft, etc. In other words, the general operating setpoint P_{ECUG} is used to determine the hybridization strategy chosen. In practice, the general operating setpoint P_{ECUG} takes the form of a power setpoint called “Setpoint PS” or a power sharing setpoint called “Mode PS”.

With reference to FIG. 6, the electrical generation system 1 comprises two generators G1, G2 connected respectively to the low-pressure shaft BP and the high-pressure shaft HP of the turbomachine T. The electrical generation system 1 comprises:
A first supply path V1 comprising:
   A first generator G1 configured to generate an alternating current by drawing mechanical energy from the low-pressure shaft BP,
   A first converter C1, associated with the first generator G1, to convert the alternating current generated into a first distribution current I_{DC1} as a function of its parameterization,
A second supply path V2 comprising:
   A second generator G2 configured to generate an alternating current by drawing mechanical energy from the high-pressure shaft HP,
   A second converter C2, associated with the second generator G2, to convert the generated alternating current into a second distribution current I_{DC2} according to its parameterization.

In this example, the generators G1, G2 are preferably electrical machines capable of operating in either generator or motor mode. In a known way, each electric machine comprises a rotor secured to a rotating shaft (here a shaft BP or a shaft HP) and a stator comprising windings so as to generate three-phase alternating currents. The structure and operation of such an electric machine are well known and will not be discussed in further detail.

With reference to FIG. 6, the electrical generation system 1 comprises an electrical distribution unit EDU which is electrically connected to the aircraft electrical network REA, to the electrical sources BAT or to the electrical charges LOAD.

Each converter C1, C2 can supply a distribution voltage V_{DC} to the electrical distribution unit EDU. Preferably, the electrical distribution unit EDU comprises a voltage bus.

In a known way, each C1, C2 converter comprises a plurality of switches, in particular transistors, which enable the electrical power generated and the mechanical power drawn from each BP, HP shaft to be modified in order to adapt the distribution current I_{DC1}, I_{DC2} as required.

According to the invention, with reference to FIG. 6, the electrical generation system 1 comprises a control device 2 configured to receive the general operating setpoint P_{ECUG} and to determine a first parameterization setpoint P_{CONS1} for the first converter C1 and a second parameterization setpoint P_{CONS2} for the second converter C2. This parameterization setpoint P_{CONS1}, P_{CONS2} is used to control the switching of the C1, C2 converter transistors.

Subsequently, each parameterization setpoint P_{CONS1}, P_{CONS2} is either a voltage-regulation setpoint RegU for slaving the C1, C2 converter to a distribution voltage V_{DC} or an auxiliary-regulation setpoint RegA, for example, a power-regulation setpoint or a torque-regulation setpoint configured to slave the converter C1, C2 to a power/torque of the high-pressure HP shaft or low-pressure shaft BP of the aircraft turbomachine.

As previously mentioned, a voltage regulation RegU can be used to control the distribution voltage V_{DC} of the electrical distribution unit EDU.

Hereinafter, with reference to FIG. 7, the term “auxiliary transition TransA” is used when a parameterization setpoint P_{CONS1}, P_{CONS2} controls the transition from a voltage regulation setpoint RegU to an auxiliary regulation setpoint RegA. Similarly, the term “voltage transition TransU” is used when a parameterization setpoint P_{CONS1}, P_{CONS2} controls the passage from a RegT, RegP auxiliary regulation setpoint to a voltage regulation setpoint RegU.

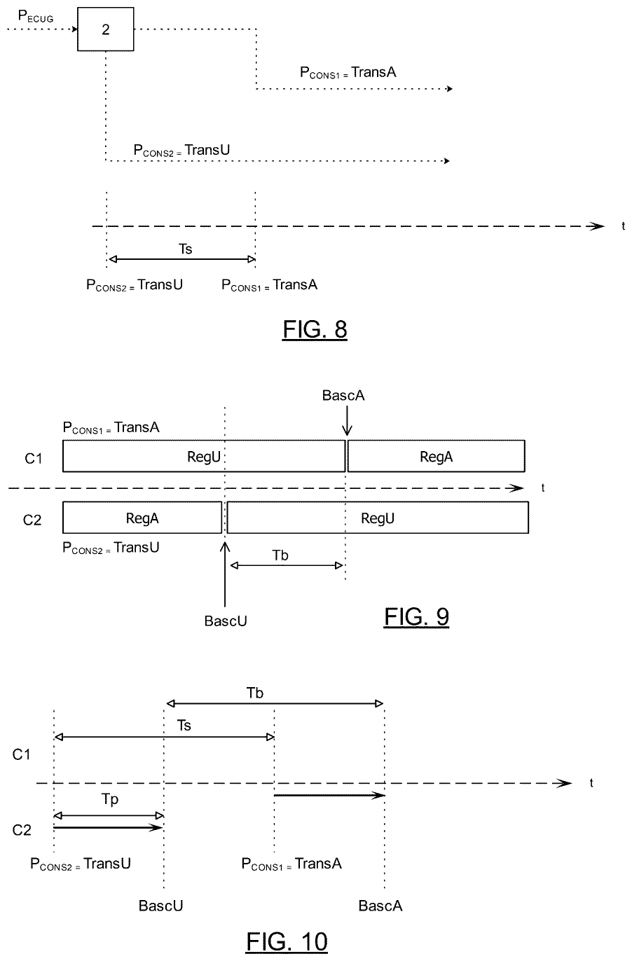

Referring to FIG. 8, the control device 2 is configured to output a parameterization setpoint during an auxiliary transition TransA with a stabilization delay Ts relative to a parameterization setpoint in relation to a voltage transition TransU. In this way, a parameterization setpoint for an auxiliary transition TransA is shifted in time relative to a parameterization setpoint for a voltage transition TransU. This enables the converter C1, C2, affected by the auxiliary transition TransA, to stabilize the distribution voltage V_{DC} temporarily to avoid instability. This is particularly advantageous if the converter C1, C2 affected by the voltage transition TransU receives its parameterization setpoint with a parasitic delay.

In the prior art, the control device 2 was configured to directly output the first parameterization setpoint P_{CONS1} for the first converter C1 and the second parameterization setpoint P_{CONS2} for the second converter C2, substantially simultaneously. The introduction of a stabilization delay Ts thus allows the time delay of control device 2 to be modified when sending its parameterization setpoints P_{CONS1}, P_{CONS2}.

With reference to FIGS. 8 to 10, during an example of implementation of nominal operation, the first converter C1 is in voltage regulation RegU while the second converter C2 is in auxiliary regulation RegA. It goes without saying that the roles of converters C1, C2 could be reversed.

As shown in FIG. 8, the computer ECU outputs a general operating setpoint P_{ECUG}, which commands the first converter C1 to be in auxiliary regulation RegA, while the second converter C2 is in voltage regulation RegU. The control device 2 outputs the first parameterization setpoint P_{CONS1} with a stabilization delay Ts relative to the second parameterization setpoint P_{CONS2}.

Referring to FIGS. 9 and 10, the first parameterization setpoint P_{CONS1} causes a switchover of the first converter C1 in auxiliary regulation RegA at an auxiliary switchover time BascA. Similarly, the second parameterization setpoint P_{CONS2} causes the second converter C2 to switch to voltage regulation RegU at a voltage switchover time BascU.

As shown in FIG. 10, the auxiliary switchover time BascA occurs after the voltage switchover time BascU with a switchover delay Tb. During the switchover delay Tb, the two converters C1, C2 operate in parallel in voltage regulation RegU. In practice, it is difficult to determine the time between the transmission of a parameterization setpoint and the associated switchover instant, due to a parasitic delay Tp (transmission delay, frame losses, etc.).

Also, the stabilization delay Ts must be calibrated to be greater than the parasitic delay Tp. Preferably, a maximum parasitic delay Tpmax is determined, for example statistically, by simulation or by feedback. The stabilization delay Ts is greater than the maximum parasitic delay Tpmax, preferably less than three times the maximum parasitic delay Tpmax, so as not to delay the auxiliary transition TransA too much. In this example, the stabilization delay Ts is twice the maximum parasitic delay Tpmax.

According to one aspect, the stabilization delay Ts is greater than 2 ms, preferably less than 45 ms. This allows a compromise between stability and responsiveness.

The stabilization delay Ts allows a time delay to ensure the quality of the electrical network during the switchover of the regulation type during a TransA auxiliary transition.

Following the introduction of the stabilization delay Ts, the two converters C1, C2 are voltage-regulated RegU in parallel for the switchover time Tb, as shown in FIG. 9. This temporary voltage regulation allows the electrical distribution unit EDU to be supplied in parallel and limits the instabilities of the distribution voltage V_{DC} as illustrated in FIG. 11.

An electric machine is known to operate in four quadrants, depending on its speed and torque. To reduce wear on an electrical machine, it is best to avoid changing quadrants during a regulation. A parallel supply remains complex because it is necessary to minimize the power drift between the two converters C1, C2 while reducing the occurrence of quadrant change (motor, generator).

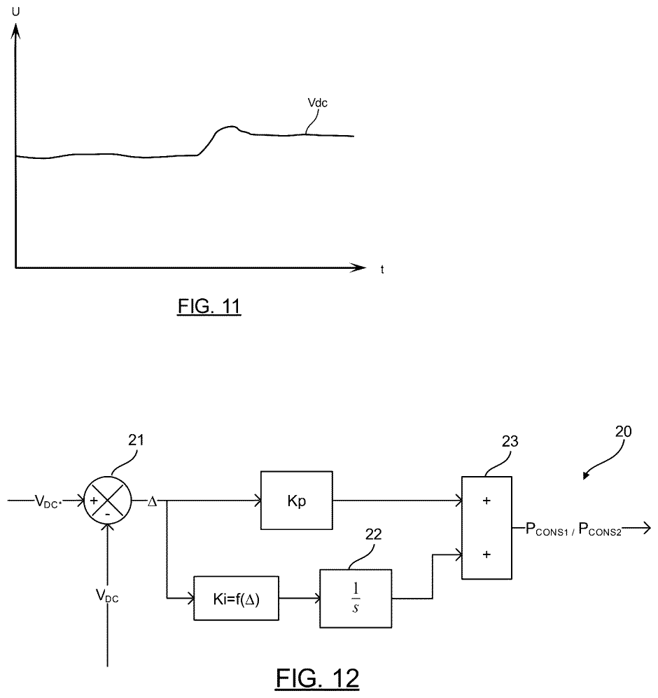

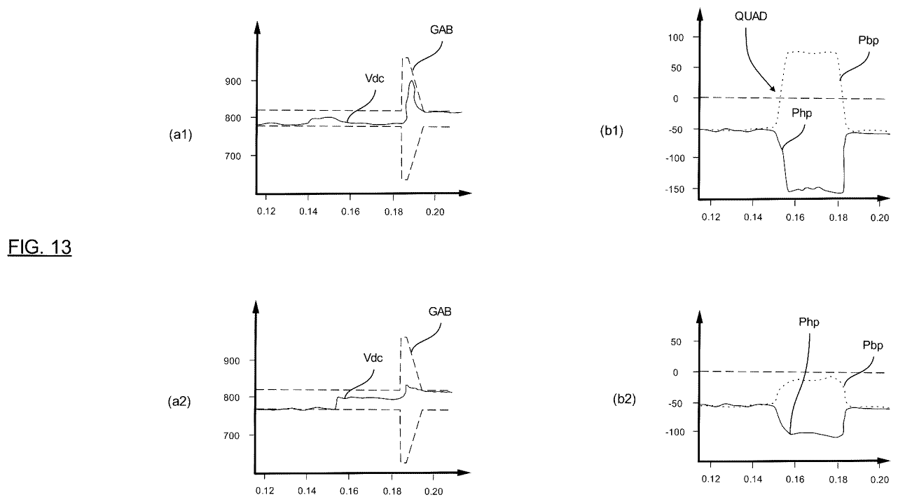

In this example, with reference to FIG. 12, the control device 2 comprises a “proportional integral” type regulation block 20, which implements a subtractor 21 that calculates a deviation A between a measurement of the distribution voltage V_{DC} and a distribution voltage setpoint V_{DC}*, a proportionality gain constant Kp, an integration gain Ki, an integrator 22 and a summation 23 so as to determine the parameterization setpoint P_{CONS1}, P_{CONS2}.

In this example, in order to introduce a stabilization delay Ts, the integration gain Ki is not a constant but a variable that depends on the deviation Δ (Ki=f(Δ)) with f a proportional function. This allows convenient modification of the regulation block 20. Thus, the integration gain Ki depends on the voltage deviation Δ in order to reduce any voltage drift. Advantageously, when the deviation Δ is small, the integration gain Ki is small. Conversely, when the gap Δ is large, the integration gain Ki is large.

The proportional function f can take several forms, for example, a staircase function (or “all or nothing”). The integration gain Ki can be equal to a first value Ki1 if the deviation Δ is less than a predetermined threshold, and the integration gain Ki can be equal to a second value Ki2, greater than the first value Ki1, if the deviation Δ is greater than said predetermined threshold. The proportional function f can also be a hysteresis-type function, linear with or without saturation.

A voltage regulation RegU based on a voltage difference Δ enables each converter C1, C2 to regulate itself optimally in order to achieve transient paralleling of the converters C1, C2. In this way, each converter C1, C2 can be conveniently regulated to supply the EDU power distribution unit. This allows the two voltage loops to work in parallel.

The regulation block 20 is used when the two converters C1, C2 are in the voltage regulation RegU.

Referring to FIG. 13, when two generators G1, G2 are operated in parallel, the two converters C1, C2 respectively supply powers Pbp, Php in order to provide a distribution voltage Vdc that must comply with a predetermined voltage gauge GAB in order to ensure network quality.

In the prior art, as illustrated by curves a1, b1 in FIG. 13, the distribution voltage Vdc is at the limits of the voltage gauge GAB and there is a change in the operating quadrant QUAD of generators G1, G2, which increases wear and tear and the risk of instability

In order to minimize the quadrant change of a generator G1, G2, during parallel operation, the converters C1, C2 are each controlled to supply half of the distribution voltage requirement V_{DC} of the electrical distribution unit EDU as shown in curve b2 of FIG. 13. The distribution voltage Vdc also complies with the voltage gauge GAB, as shown in curve a2 in FIG. 13.

So, even if the power output of the two generators G1, G2 drifts during paralleling, there will be no change in the operating quadrant of the generators G1, G2, which advantageously limits wear and tear and the risk of instability.

Thanks to the invention, a role reversal of converters C1, C2 can be carried out without instability on the distribution voltage VDC thanks to the introduction of a stabilization delay Ts which allows a temporary paralleling of the converters C1, C2.

1. An electrical generation system for powering at least one electrical network of an aircraft, the aircraft comprising at least one aircraft turbomachine comprising a low-pressure shaft and a high-pressure shaft configured to be driven in rotation, the electrical generation system being configured to receive a general operating setpoint defining a hybridization strategy, the electrical generation system comprising:
an electrical distribution unit having a distribution voltage,
a first supply path comprising:
a first generator configured to generate an alternating current by drawing mechanical energy from one of the low-pressure shaft and high-pressure shaft,
a first converter, associated with the first generator for supplying the electrical distribution unit, configured to convert the alternating current generated into a first distribution current as a function of its parameterization,
a second supply path comprising:
a second generator configured to generate an alternating current by drawing mechanical energy from the other of the low-pressure shaft and the high-pressure shaft,
a second converter, associated with the second generator for supplying the electrical distribution unit, configured to convert the alternating current generated into a second distribution current as a function of its parameterization,
a control device configured to receive the general operating setpoint and output a first parameterization setpoint for the first converter and a second parameterization setpoint for the second converter,
each of the parameterization setpoints being either a voltage regulation setpoint for slaving the converter to a distribution voltage or an auxiliary regulation setpoint for the turbomachine,
the control device being configured to output a parameterization setpoint in relation to an auxiliary transition, defined during a transition from a voltage regulation setpoint to an auxiliary regulation setpoint, with a stabilization delay relative to a parameterization setpoint in relation to a voltage transition, defined during a transition from an auxiliary regulation setpoint to a voltage regulation setpoint, so that the voltage regulation is extended during an auxiliary transition.

2. The electrical generation system according to claim 1, wherein the stabilization delay is greater than 2 ms.

3. The electrical generation system according to claim 1, wherein the stabilization delay is less than 45 ms.

4. The electrical generation system according to claim 1, wherein the stabilization delay is greater than a maximum parasitic delay determined between an instant of emission of a parameterization setpoint in relation to a transition and an instant of effective switchover from one regulation to another.

5. The electrical generation system according to claim 4, wherein the stabilization delay is less than three times the maximum parasitic delay.

6. The electrical generation system according to claim 5, wherein the stabilization delay is substantially equal to twice the maximum parasitic delay.

7. The electrical generation system according to claim 1, wherein the control device comprises a regulation block configured to calculate a deviation between a measurement of the distribution voltage and a distribution voltage setpoint, the regulation block comprising a gain parameter which is proportionally dependent on the deviation.

8. The aircraft comprising the at least one aircraft turbomachine comprising the low-pressure shaft and the high-pressure shaft configured to be driven in rotation, at least one of the electrical generation systems according to claim 1, supplying at least one electrical network of the aircraft.

9. An electrical generation method for supplying at least one of the electrical networks of the aircraft from the electrical generation system according to claim 1, the aircraft comprising at least one of the aircraft machines comprising the low-pressure shaft and the high-pressure shaft configured to be driven in rotation, the method comprising:
receiving a general operating setpoint defining a hybridization strategy,.
outputting a first parameterization setpoint for the first converter and a second parameterization setpoint for the second converter, from the general operating setpoint, and
outputting a parameterization setpoint for an auxiliary transition with a stabilization delay relative to a parameterization setpoint for a voltage transition, so that the voltage regulation is extended during an auxiliary transition.

10. A computer program-type product comprising at least one sequence of instructions which is stored and readable by a processor and which, when read by said processor, causes the steps of the method of claim 9 to be performed.
